(19) United States
(12) Patent Application Publication
(10) Pub. No.: US 2009/0033095 A1
(43) Pub. Date: Feb. 5, 2009

(54) Regenerating an engine exhaust gas particulate filter in a hybrid electric vehicle

(76) Inventors: Deepak Aswani, Westland, MI (US); Mathew A. Boesch, Plymouth, MI (US); Ihab S. Soliman, Warren, MI (US); Andrew J. Silveri, Royal Oak, MI (US); Fazal U. Syed, Canton, MI (US); Mark S. Yamazaki, Canton, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/888,464

(22) Filed: Aug. 1, 2007

(51) Int. Cl. F01N 3/023; F02C 6/04

(52) U.S. Cl. 290/2; 60/295; 60/311

(57) ABSTRACT

In a powertrain that includes an engine having a filter for removing particulate matter from engine exhaust gas, and an electric machine driveably connected to the engine, a method for controlling temperature of the filter including operating the engine to produce a magnitude of positive crankshaft power for driving the vehicle, increasing the temperature of the engine exhaust gas by operating the electric machine to increase load on the engine, and regenerating the particulate filter by passing engine exhaust gas at the increased temperature through the particulate filter.

### BACKGROUND OF THE INVENTION

1. Field of the Invention

This invention relates generally to an after-treatment system having a particulate filter for treating exhaust gas from an engine in a hybrid electric vehicle.

2. Description of the Prior Art

A hybrid electric vehicle (HEV) for a motor vehicle includes a powertrain for transmitting rotary power from multiple power sources to the wheel load at the driven wheels of the vehicle. One power source is an internal combustion engine, such as a diesel engine having an engine exhaust gas after-treatment system equipped with a diesel particulate filter (DPF). Appropriate “hybrid electric” configurations are any configuration in which there exists an electric machine (with motoring and generating capabilities) whose torque output is directly or indirectly coupled to the torque output of the internal combustion (IC) engine.

The diesel particulate filter (DPF) removes undesirable particulate matter from diesel exhaust by physical filtration. Diesel particulate matter from diesel engine exhaust is classified as a pollutant because it is known to increase risk of causing for asthma, lung cancer, and cardiovascular problems. DPFs are commonly made of some ceramic honeycomb monolith. Channels of a substrate are commonly blocked at alternate ends so the exhaust gasses must flow through the walls between the channels to improve the deposition of particulate matter.

Other materials are sometimes used for the filtration medium such as sintered metal plates, foamed metal structures, fiber mats, and etc.

DPFs have a finite capacity; therefore, they must be cleaned intermittently by regeneration to remove the accumulation of particulate matter. Otherwise, an overfilled DPF can lead to excessive exhaust back pressure, poor engine efficiency and performance, or result in damage of the DPF itself.

### SUMMARY OF THE INVENTION

In a powertrain that includes an engine having a filter for removing particulate matter from engine exhaust gas, and an electric machine driveably connected to the engine, a method for controlling temperature of the filter including operating the engine to produce a magnitude of positive crankshaft power for driving the vehicle, increasing the temperature of the engine exhaust gas by operating the electric machine to increase load on the engine, and regenerating the particulate filter by passing engine exhaust gas at the increased temperature through the particulate filter.

The method requires no equipment specific to regenerating the DPF other than the equipment required to transmit power to the wheels. The method does not restrict the engine operating point to exactly follow the driver demand due to the presence of a two-way energy storage device, i.e., an electric storage battery. By biasing the engine torque demand higher than the engine torque require to produce nominal wheel torque, the exhaust temperature can be increased.

This method does not compromise emissions since no post-injection is involved; therefore, the bulk of fuel burn occurs during the combustion stroke. Furthermore, system efficiency is not substantially compromised since the additional fuel injected in the engine is completely burned and a portion of this additional energy is absorbed by the electrical machine and used to charge the hybrid electric battery.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWING

The invention will be more readily understood by reference to the following description, taken with the accompanying drawings, in which:

FIG. 1 is a schematic diagram of a HEV powertrain embodiment;

FIG. 2 is a schematic diagram of a second HEV powertrain embodiment;

FIG. 3 is a schematic diagram of a third second HEV powertrain embodiment; and

FIG. 4 is a schematic diagram of a fourth HEV powertrain embodiment.

### DESCRIPTION OF THE PREFERRED EMBODIMENT

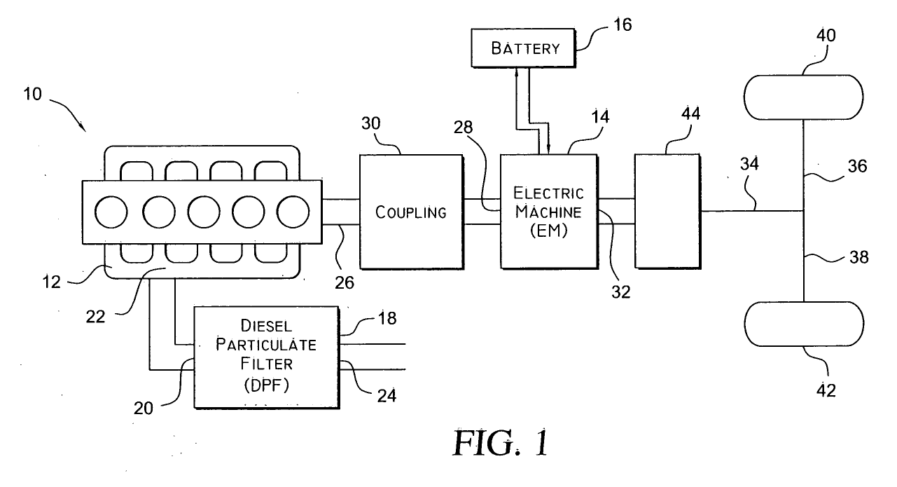

FIG. 1 illustrates a HEV powetrain 10 that includes an internal combustion engine 12, such as a diesel engine, and an electric machine 14, preferably a starter-generator, able to crank the engine during its starting procedure and able to generate electric energy. An electric storage battery 16, electrically connected to the electric machine 14, stores energy produced by the electric machine and delivers energy to the electric machine in order to crank the engine.

A particulate filter 18 includes an inlet 20, which is connected to the exhaust manifold 22 of the engine 12, and an outlet 24, through which exhaust gas from the engine exits the filter 18 and flows to the atmosphere. The particulate filter 18 is referred to as a diesel particulate filter (DPF) when the powertrain 10 includes a diesel engine.

The input 28 of electric machine 14 is driveably connected by a coupling 30 to the engine crankshaft 26. The output 32 of electric machine 14 is driveably connected, through a drive shaft 34 and axles 36, 38, to a road load represented by torque transmitted to the wheels 40, 42, on which the vehicle is supported. An additional electric machine 44, such as an electric motor, is driveably connected to the electric machine's output 32 and to driveshaft 34.

At least one of the electric machines 14, 44 is used to produce negative torque on the engine 12 in opposition to the output torque produced by the engine to drive the wheels 40, 42. In order to meet the vehicle operator's demand for wheel torque, the engine 12 must produce a greater magnitude of torque than would be required to produce the required wheel torque due to the negative torque loading produced by the electric machine 14, 44. The load produced by the electric machines 14, 44 on the engine 12 in addition to the road load causes an increase the temperature of the exhaust gas that flows through the exhaust manifold 22 and DPF 18.

When the powertrain is operating to heat and regenerate the DPF 18, and the electric machine 14 is operating as an electric generator to increase the load on engine 12, some of the energy used to increase the temperature of the DPF with the hotter exhaust gas is recovered and stored in battery 16 in the form of electric energy produced by the generator of the electric machine 14, thereby increasing the battery's state of charge (SOC).

After the DPF 18 has been regenerated, the load on the engine 12 due to the electric machine 14 is eliminated or reduced below the torque nominally requested or the torque required to produce the demanded wheel torque. The reduction in load on the engine causes the temperature of the exhaust to fall, thereby allowing the DPF 18 to cool.

Negative torque produced by electric machine 14 and the additional machine 44 is transmitted through coupling 30 to the engine 12. Positive torque produced by engine 12, electric machine 14 and the additional machine 44 is transmitted to the wheels 40, 42 through drive shaft 34.

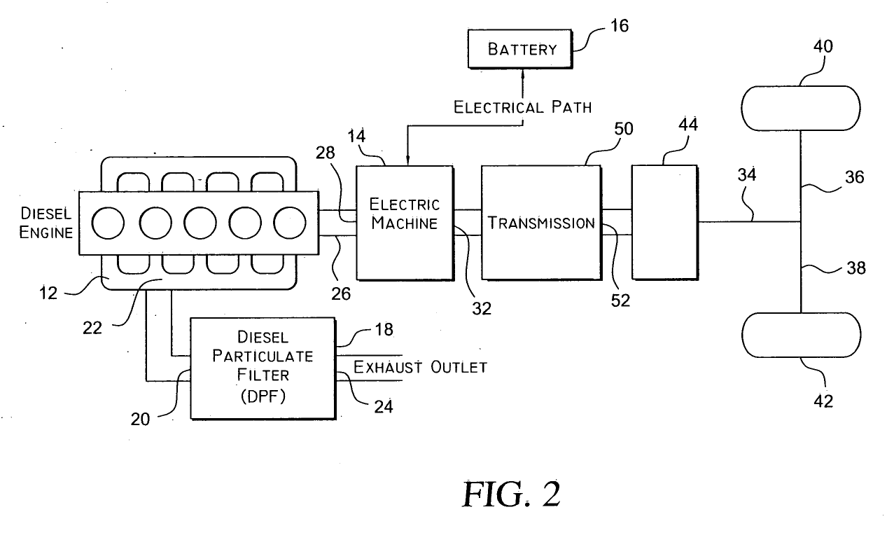

FIG. 2 illustrates a powertrain embodiment in which the input 28 of the electric machine 14 is driveably connected to the engine crankshaft 26, and the output 32 is driveably connected to a power transmission 50, whose output is connected to the additional electric machine 44.

Negative torque produced by electric machine 14 is transmitted directly to engine 12, and negative torque produced by the additional machine 44 is transmitted through transmission 50 to the engine 12. Positive torque produced by engine 12, electric machine 14 and the additional machine 44 is transmitted to the wheels 40, 42 through drive shaft 34.

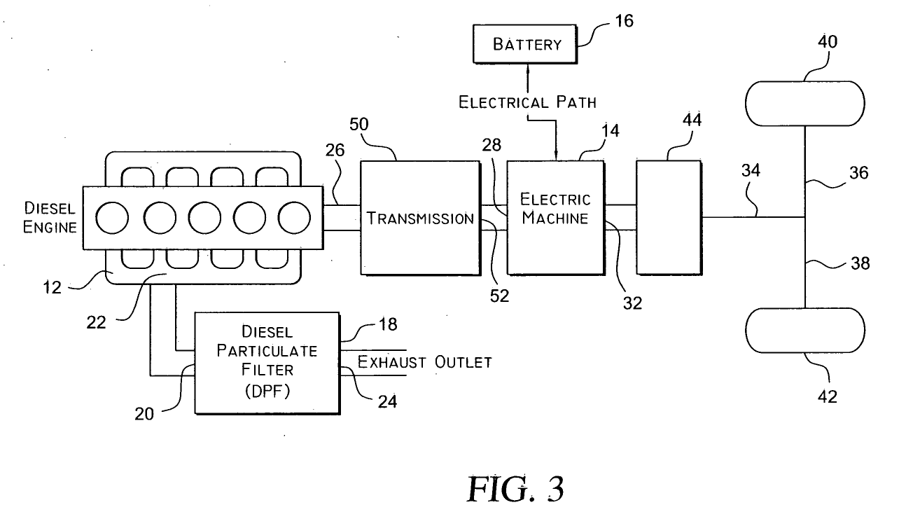

FIG. 3 illustrates a third powertrain embodiment in which the input 28 of the electric machine 14 is driveably connected to the output 52 of transmission 50, the output 32 of the electric machine 14 is driveably connected to the additional electric machine 44, and the engine crankshaft 26 is driveably connected to the input of transmission 50. Driveshaft 30 connects the output of machine 44 to wheels 34, 35.

Negative torque produced by electric machine 14 and additional machine 44 is transmitted through transmission 50 to engine 12. Positive torque produced by engine 12 is transmitted through transmission 50 to electric machine 14, whose positive output torque is combined with that of the engine and the additional machine 44 and is transmitted to the wheels 40, 42 through drive shaft 34.

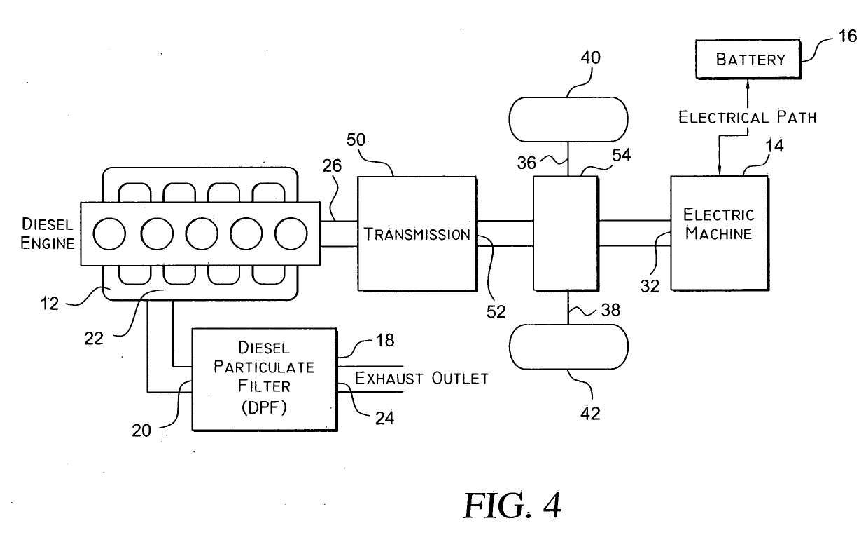

FIG. 4 illustrates a powertrain embodiment in which the engine crankshaft 26 is driveably connected to the input of transmission 50, the output 52 of the transmission is driveably connected to a device 54, such as a differential mechanism, which transmits power to the wheels 40, 42, and the output 32 of the electric machine 14 is driveably connected to wheels 34, 35 through the device 46.

Negative torque produced by electric machine 14 is transmitted through transmission 50 to engine 12. Positive torque produced by engine 12 is transmitted through transmission 50 to the wheels 40, 42, and positive torque produced by electric machine 14 is transmitted to the wheels 40, 42 through device 54.

Positive torque is torque transmitted in the direction from the engine 12 to the wheels 40, 44. Negative torque is torque transmitted in the direction toward the engine, from the wheels 40, 44 or one of the electric machines 14, 44.

In each embodiment, torque produced by the engine 12 can be amplified by the transmission 40. Preferably, transmission 40 produces multiple gear ratios, and is one of an automatic transmission producing step changes in the operating gear ratio, a continuously variable transmission producing a range a stepless gear ratios, a converterless powershift transmission producing step changes in the operating gear ratio, and a manual transmission.

The powertrain 10 requires no equipment specific to regenerating the DPF 18 other than that required to transmit power to the wheel from the power sources, i.e., engine 12, electric machine 14 and any additional electric machine 36.

The particulate material trapped in the DPF 18 is mostly carbon particles with some absorbed hydrocarbons. Regeneration of the DPF 18 occurs within the filter in two chemical reactions. The carbon particles within the DPF 18 participate in a first reaction: combustion with oxygen contained in the engine exhaust gas at about 550° C. (or about 360° C. when a fuel-borne catalyst is present), thereby producing carbon dioxide as a product of the combustion. A suitable fuel-borne catalyst for this purpose is fuel doped with a small amount of iron, or strontium or both iron and strontium, having a concentration of about 200 wt. ppm. The carbon particles within the DPF ]8 may participate in a second reaction: combustion with nitrogen dioxide contained in the engine exhaust oxygen at about 230° C., thereby producing carbon dioxide and nitric oxide as products of the combustion.

The reactants for the first reaction are abundant in diesel exhaust and are therefore the preferred means of executing DPF regeneration. The temperature of the regeneration process for the first reaction must be carefully controlled around the target temperature about 550° C., or 360° C. when a fuel-borne catalyst is present. If the temperature of the DPF falls too low the regeneration process may end prematurely requiring a significant amount of heat energy to be added to the DPF to restart the process due to the usually low temperature of diesel exhaust. If the temperature of the DPF is too high, the diesel particulate matter may burn uncontrolled in the DPF, thereby rapidly increasing temperature of the DPF, and quickly damaging or destroying the DPF. Therefore, careful thermal control of a DPF is critical for an efficient, effective, non-destructive regeneration.

In accordance with the provisions of the patent statutes, the preferred embodiment has been described. However, it should be noted that the alternate embodiments can be practiced otherwise than as specifically illustrated and described.

What is claimed is:

1. In a powertrain that includes an engine having a filter for removing particulate matter from engine exhaust gas, and an electric machine driveably connected to the engine, a method for controlling temperature of the filter comprising the steps of:
(a) operating the engine to produce a magnitude of positive crankshaft power for driving the vehicle;
(b) operating the electric machine such that crankshaft power produced by the engine is increased and a temperature of the engine exhaust gas is greater than a reference temperature; and
(c) regenerating the particulate filter by passing engine exhaust gas at the increased temperature through the particulate filter.

2. The method of claim 1 wherein step (b) further includes the steps of:
operating the electric machine as an electric generator; and
storing electric energy produced by the electric machine in an electric storage battery.

3. The method of claim 1 further including the step of:
decreasing the temperature of the engine exhaust gas by operating the electric machine such that engine load is decreased; and
passing engine exhaust gas at the decreased temperature through the particulate filter.

4. The method of claim 1 further including the steps of:
operating the electric machine to produce positive torque;
transmitting the positive torque produced by the electric machine to the load; and
decreasing the magnitude of positive crankshaft power produced by the engine.

5. The method of claim 1 further including the steps of:
operating the electric machine as an electric motor; and
using electric energy from an electric storage battery to drive the electric machine;
transmitting the positive torque produced by the electric machine to the load.

6. The method of claim 5 further including the step of decreasing the magnitude of positive crankshaft power produced by the engine.

7. In a powertrain that includes a diesel engine having a filter for removing particulate matter from diesel engine exhaust gas, and an electric machine driveably connected to the engine, a method for controlling temperature of the filter comprising the steps of:
(a) operating the engine to produce a magnitude of positive crankshaft power for driving the vehicle;
(b) increasing a temperature of the engine exhaust gas by operating the electric machine such that load on the engine is increased; and
(c) regenerating the particulate filter by passing engine exhaust gas through the particulate filter at a temperature at which combustion of carbon particles within the filter with oxygen contained in the engine exhaust gas occurs.

8. The method of claim 7 wherein step (b) further includes the step of increasing the temperature of the engine exhaust gas to about 550-620° C.

9. The method of claim 7 wherein step (b) further includes the steps of:
operating the electric machine as an electric generator; and
storing electric energy produced by the electric machine in an electric storage battery.

10. The method of claim 7 further including the step of:
decreasing the temperature of the engine exhaust gas by operating the electric machine such that engine load is decreased; and
passing engine exhaust gas at the decreased temperature through the particulate filter.

11. The method of claim 7 further including the steps of:
operating the electric machine to produce positive torque;
transmitting the positive torque produced by the electric machine to the load; and
decreasing the magnitude of positive crankshaft power produced by the engine.

12. The method of claim 7 further including the steps of:
operating the electric machine as an electric motor;
using electric energy from an electric storage battery to drive the electric machine; and
transmitting the positive torque produced by the electric machine to the load.

13. The method of claim 12 further including the step of decreasing the magnitude of positive crankshaft power produced by the engine.

14. The method of claim 7 wherein step (b) further includes the steps of:
doping the fuel with at least one of iron and strontium such that the engine exhaust gas has a concentration of about 200 parts per million by weight; and
increasing the temperature of the engine exhaust gas to about 360° C.

15. In a powertrain that includes a diesel engine having a filter for removing particulate matter from diesel engine exhaust gas, and an electric machine driveably connected to the engine, a method for controlling temperature of the filter comprising the steps of:
(a) operating the engine to produce a magnitude of positive crankshaft power for driving the vehicle;
(b) increasing a temperature of the engine exhaust gas by operating the electric machine such that load on the engine is increased; and
(c) regenerating the particulate filter by passing engine exhaust gas through the particulate filter at a temperature at which combustion of carbon particles within the filter with nitrogen dioxide contained in the engine exhaust gas occurs.

16. The method of claim 15 wherein step (b) further includes the step of increasing the temperature of the engine exhaust gas in the filter to about 230° C.

17. The method of claim 15 wherein step (b) further includes the steps of:
operating the electric machine as an electric generator; and
storing electric energy produced by the electric machine in an electric storage battery.

18. The method of claim 15 further including the step of:
decreasing the temperature of the engine exhaust gas by operating the electric machine to decrease load on the engine; and
passing engine exhaust gas at the decreased temperature through the particulate filter.

19. The method of claim 15 further including the steps of:
operating the electric machine to produce positive torque;
transmitting the positive torque produced by the electric machine to the load; and
decreasing the magnitude of positive crankshaft power produced by the engine.

20. The method of claim 15 further including the steps of:
operating the electric machine as an electric motor;
using electric energy from an electric storage battery to drive the electric machine; and
transmitting the positive torque produced by the electric machine to the load.
